(19) United States
(12) Patent Application Publication
(10) Pub. No.: US 2017/0004551 A1
(43) Pub. Date: Jan. 5, 2017

(54) PURCHASING METHOD AND SYSTEM

(71) Applicants: SHLOMO COHEN, GIVAT KOACH (IL); YANIV WINER, GIVAT SHMUEL (IL)

(72) Inventors: SHLOMO COHEN, GIVAT KOACH (IL); YANIV WINER, GIVAT SHMUEL (IL)

(21) Appl. No.: 15/201,514

(22) Filed: Jul. 4, 2016

(30) Foreign Application Priority Data
Jul. 5, 2015 (IL) 239793

(51) Int. Cl. G06Q 30/06; G06K 7/10

(52) U.S. Cl. CPC G06Q 30/0605; G06Q 30/0613; G06K 7/10861; G06Q 50/01

(57) ABSTRACT

A purchasing method, including the steps of: providing by at least one customer, at least one initial offer to a computerized control center, the at least initial offer including a price for an identified item; forwarding, by the computerized control center, the at least one initial offer to a plurality of vendors; forwarding by at least one of the plurality of vendors, as responses to the at least one initial offer, at least one response offer, to the computerized control center; selecting, by the computerized control center, from the at least one response offer, at least one response offer, and forwarding thereof to the at least one customer, thereby supporting said at least one customer in receiving offers.

### CROSS-REFERENCE TO RELATED APPLICATIONS

This application claims the benefit of priority from Israel Patent Application No. 239793, filed Jul. 5, 2015, the disclosure of which is incorporated herein by reference.

### TECHNICAL FIELD

The invention relates to the field of bids. More particularly, the invention relates to a method and system for managing purchasing.

### BACKGROUND

A vendor accompanies himself with marketing tools for selling the relatively routine goods or services thereof. The tools include technological means.

In contrast, a customer does not have purchasing tools, since the goods or services thereof are changing.

### SUMMARY

The invention provides a solution to the above-mentioned and other problems of the prior art.

In one aspect of the invention, the invention provides a method and system for accompanying a customer in purchasing.

In one aspect, the invention is directed to a purchasing method, including the steps of:
providing by at least one customer, at least one initial offer to a computerized control center, the at least initial offer including a price for an identified item;
forwarding, by the computerized control center, the at least one initial offer to a plurality of vendors;
forwarding by at least one of the plurality of vendors, as responses to the at least one initial offer, at least one response offer, to the computerized control center;
selecting, by the computerized control center, from the at least one response offer, at least one response offer, and forwarding thereof to the at least one customer,
   thereby supporting said at least one customer in receiving offers.

### BRIEF DESCRIPTION OF THE DRAWINGS

Embodiments, features, and aspects of the invention are described herein in conjunction with the following drawings:

FIG. 1 depicts the first step of the purchasing.

FIG. 2 depicts a preliminary step, for operating the first step of FIG. 1.

FIG. 3 depicts the steps of the purchasing.

FIG. 4 depicts an example of the fourth step of FIG. 3.

The drawings are not necessarily drawn to scale.

### DETAILED DESCRIPTION

The invention will be understood from the following detailed description of embodiments of the invention, which are meant to be descriptive and not limiting. For the sake of brevity, some well-known features, methods, systems, procedures, components, circuits, and so on, are not described in detail.

The reference numbers have been used to point out elements in the embodiments described and illustrated herein, in order to facilitate the understanding of the invention. They are meant to be merely illustrative, and not limiting. Also, the foregoing embodiments of the invention have been described and illustrated in conjunction with systems and methods thereof, which are meant to be merely illustrative, and not limiting.

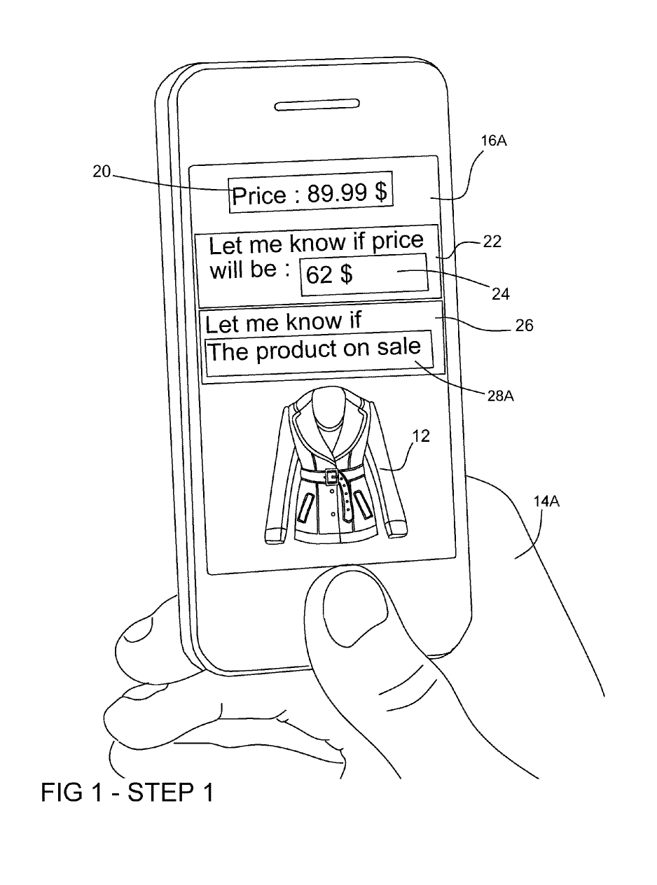

FIG. 1 depicts the first step of the purchasing.

At the first step, a potential customer 14A forwards an offer to buy a certain item 12 for a certain price 24.

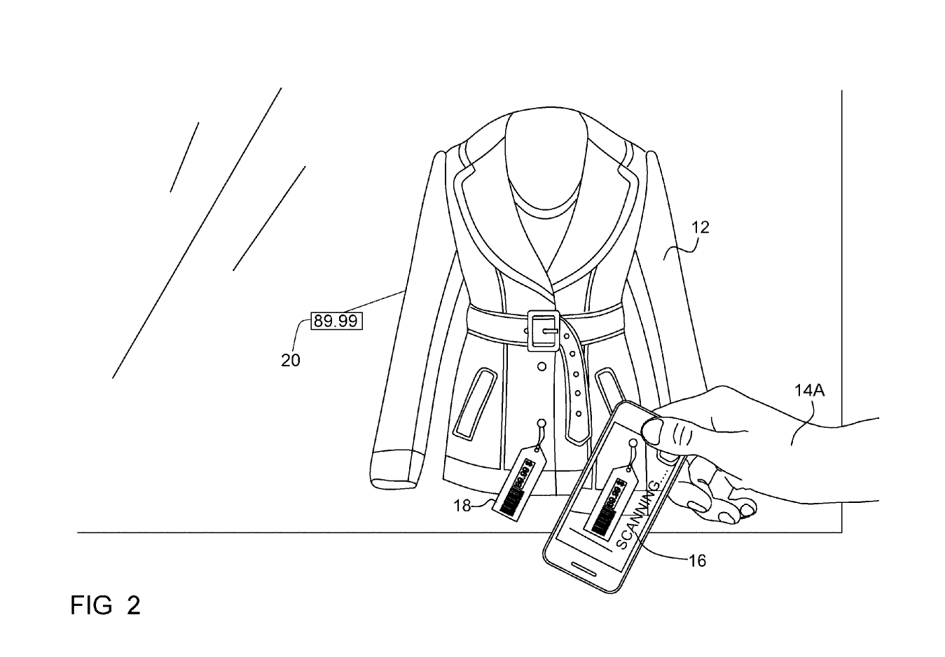

FIG. 2 depicts a preliminary step, for operating the first step of FIG. 1.

The certain item 12 may be identified and then indicated such as by scanning the barcode 18 of the item or by processing a photograph, provided by customer 14A.

The scanning may be applied by the application, through which the customer provides the offer thereof to the computerized control center.

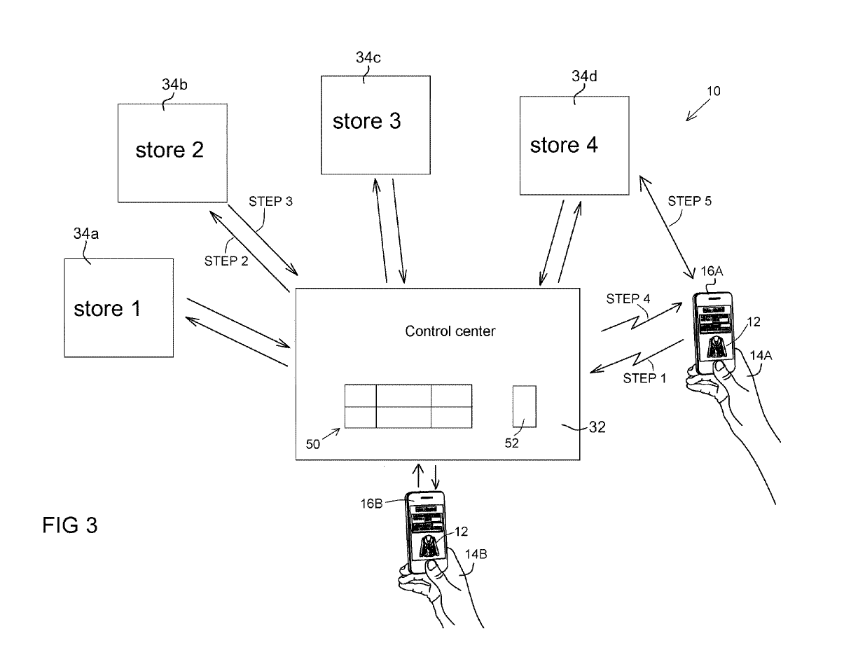

FIG. 3 depicts the steps of the purchasing.

The request of the first step is forwarded by customer 14A to a computerized control center 32.

At the second step, computerized control center 32 forwards the offer to a plurality of vendors, namely 34a, 34b, 34c, 34d. This forwarding requires that computerized control center 32 determines the field of the item, for instance field of clothes for item 12 being a jacket, and thus computerized control center 32 forwards the offer to clothes vendors only.

Computerized control center 32 may analyze the identified item, and advise substitutes.

At the third step, the vendors respond, each by their offers.

At the fourth step, computerized control center 32 sorts the offers, and provides customer 14A with the relevant offers.

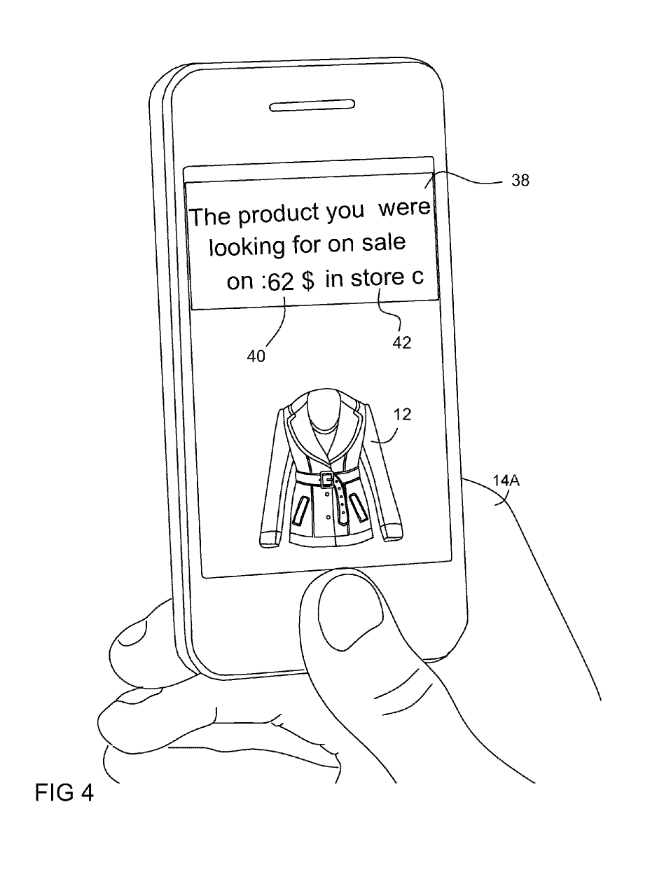

FIG. 4 depicts an example of the fourth step of FIG. 3.

At the fifth step, and referring again to FIG. 3, customer 14A and the vendor, selected by the customer, say vendor 34d, may make the transaction.

The transaction may be based on a coupon produced by computerized control center 32, between customer 14A and vendor 34d, including identifying details, and which may be encoded.

Using of the coupon provides the information to computerized control center 32, thus knowing that vendor 34d indeed did not just offer the item without the capability to supply it.

Steps 1 to 4 may be carried within seconds, thus the system must be computerized and communicated.

In other cases, the period between the first step to the fourth step might be long, depending on commercial events, where in spite of that, each of the steps must carried at a limited period, thus again, the system must be computerized and communicated.

Each of the offers, including the customer's first offer, and the vendors' offers, may include various parameters and conditions for the purchasing, such as preferences of the customers, location of the customers, etc.

Field 26 in FIG. 1 shows a customer's preference between option 28A and another option (not shown).

Especially the parameters include prices per amounts and dates for each offer, which may constitute estimates only.

Thus, the offers of vendors 34a, 34b, etc. as responses to the offer of customer 14A, may take in account also offers of another customer 14B for the same item 12.

The system must analyze the data also for deciding which offer is relevant to the offer of the customer. The system must also decide whether and how long is it efficient to wait for improving the offers, and who should wait.

The site 32 may provide information regarding offers of vendors, even without providing the identity of the vendor, and may produce graphs of the improvement of the offers from along the time of the bid.

Thus, computerized control center 32 includes a database 50 containing the offers of customers 14A, 14B and others, and the offers of vendors 34a, 34b, and others; and an engine 52 for obtaining decisions based on database 50.

The decisions may include recommendations to the customers and to the vendors, such as whether to wait to a group of customers, having shared interests.

In contrast to conventional bids, which seek for customers, system 10 constitutes a purchasing system, as it serves customers 14A, 14B, who do not have their own advertising means, and thus the first step is executed by the customer 14A regarding a certain item 12.

Thus, in one aspect, the invention is directed to a purchasing method, including the steps of:
providing by at least one customer (14A), at least one initial offer to a computerized control center (32), the at least initial offer including a price (24) for an identified item (12);
forwarding, by the computerized control center (32), the at least one initial offer to a plurality of vendors (34a, 34b);
forwarding by at least one of the plurality of vendors (34a, 34b), as responses to the at least one initial offer, at least one response offer, to the computerized control center (32);
selecting, by the computerized control center (32), from the at least one response offer, at least one response offer, and forwarding thereof to the at least one customer (14A),
   thereby supporting said at least one customer (14A) in receiving offers.

The at least one customer (14A) may include a plurality of customers (14A, 14B),
thereby the step of forwarding, by the computerized control center (32), the at least one initial offer to a plurality of vendors (34a, 34b), includes forwarding a plurality of initial offers for the identified item (12),
thereby supporting the at least one customer (14A) in gathering a group of customers (14A, 14B).

The step of selecting, by the computerized control center (32), from the at least one response offer, at least one response offer, may include the step of considering parameters of the at least one initial offer and of the at least one response offer.

The parameters may include: supply date, location of supply, substitutes to said identified item (12), payment terms. Each person may receive a different offer, based on historical purchases.

The purchasing method may further include the step of:
scanning, by the at least one customer (14A), a barcode (18) of the identified item (12) for identifying thereof.

The purchasing method may further include the step of:
photographing, by the customer (14A), the identified item (12), and
identifying the item (12) by image processing.

This and other steps, cannot be managed by telephonic conversations.

In another aspect, the invention is directed to a purchasing system, including:
a computerized control center (32), for receiving at least one initial offer from at least one customer (14A) initiating thereof, the at least initial offer including a price (24) for an identified item (12);
a database (50), for storing the at least one initial offer;
communication means,
for forwarding by the computerized control center (32), the at least one initial offer to a plurality of vendors (34a, 34b), and
for receiving from at least one of the plurality of vendors (34a, 34b), as responses to the at least one initial offer, at least one response offer; and
an engine (52), for selecting from the at least one response offer, at least one response offer,
   thereby supporting said at least one customer (14A) in receiving offers.

In the figures and/or description herein, the following reference numerals (Reference Signs List) have been mentioned:
numeral 10 denotes the purchasing system, according to one embodiment of the invention;
numeral 12 denotes the certain item, being desired by the customer;
numerals 14A and 14B denote customers, desiring the same item, and each offering a price thereof;
numerals 16A and 16B denote smart phones of customers 14A and 14B respectively;
numeral 18 denotes the barcode of the item being scanned;
numeral 20 denotes the price of the item, being available to the customer; however, the customer desires to purchase the item for a lower price;
numeral 24 denotes the price being offered by the customer; this price is referred as “initial offer”;
numeral 26 denotes a selection field;
numeral 28 denotes a selection, being selected from a selection field;
numeral 32 denotes a computerized control center;
numerals 34a, 34b, 34c and 34d denote vendors or stores;
numeral 38 denotes a message produced by the computerized control center;
numeral 40 denotes the price offered by one of the vendors, being relevant to the customer;
numeral 42 denotes the vendor, offering the relevant offer;
numeral 50 denotes a database handled by the computerized control center; and
numeral 52 denotes an engine, for analyzing the database.

The foregoing description and illustrations of the embodiments of the invention has been presented for the purposes of illustration. It is not intended to be exhaustive or to limit the invention to the above description in any form.

Any term that has been defined above and used in the claims, should to be interpreted according to this definition. The reference numbers in the claims are not a part of the claims, but rather used for facilitating the reading thereof. These reference numbers should not be interpreted as limiting the claims in any form.

What is claimed is:

1. A purchasing method, comprising the steps of:
providing by at least one customer, at least one initial offer to a computerized control center, said at least initial offer comprising at least a price for an identified item;
forwarding, by said computerized control center, said at least one initial offer to a plurality of vendors;
forwarding by at least one of said plurality of vendors, as responses to said at least one initial offer, at least one response offer, to said computerized control center;
selecting, by said computerized control center, from said at least one response offer, at least one response offer if available, and forwarding thereof to said at least one customer,
thereby supporting said at least one customer in receiving offers.

2. A purchasing method according to claim 1, wherein said at least one customer comprises a plurality of customers,
thereby said step of forwarding, by said computerized control center, said at least one initial offer to a plurality of vendors, comprises forwarding a plurality of initial offers for said identified item,
thereby supporting said at least one customer in gathering a group of customers, for ordering a greater quantity of said identified item.

3. A purchasing method according to claim 1, wherein said step of selecting, by said computerized control center, from said at least one response offer, at least one response offer, comprises the step of considering parameters of said at least one initial offer and of said at least one response offer.

4. A purchasing method according to claim 3, wherein said parameters of said at least one initial offer and of said at least one response offer comprise at least one member selected from a group consisting of: supply date, location of supply, substitutes to said identified item, payment terms, personal pricing, consideration of historical purchases.

5. A purchasing method according to claim 1, further comprising the step of:
scanning, by said at least one customer, a barcode of said identified item for identifying thereof.

6. A purchasing method according to claim 1, further comprising the step of:
photographing, by said at least one customer, said identified item, and
identifying said item by image processing.

7. A purchasing system, comprising:
a computerized control center, for receiving at least one initial offer from at least one customer initiating thereof, said at least initial offer comprising a price for an identified item;
a database, for storing said at least one initial offer;
communication means,
for forwarding by said computerized control center, said at least one initial offer to a plurality of vendors, and
for receiving from at least one of said plurality of vendors, as responses to said at least one initial offer, at least one response offer; and
an engine, for selecting from said at least one response offer, at least one response offer,
thereby said purchasing system comprises a social network of customers and of vendors.
